(19) United States
(12) Patent Application Publication
(10) Pub. No.: US 2021/0259415 A1
(43) Pub. Date: Aug. 26, 2021

(54) GUIDE ROLLERS FOR STORAGE AND RETRIEVAL UNITS

(71) Applicant: MIAS Maschinenbau, Industrieanlagen & Service GmbH, Eching (DE)

(72) Inventors: Antonio HOHNHORST, Olching (DE); Martin HOOLE, Munich (DE); Manuel MOTILVA, Germering (DE)

(21) Appl. No.: 17/185,323

(22) Filed: Feb. 25, 2021

(30) Foreign Application Priority Data
Feb. 26, 2020 (DE) 10 2020 202 436.7

(51) Int. Cl. A47B 88/437; A47B 88/493

(52) U.S. Cl. CPC A47B 88/437; A47B 2210/0037; A47B 88/493

(57) ABSTRACT

The present invention relates to a guide roller arrangement (10) for a storage and retrieval unit, comprising: a connection portion (12) configured to enable rigid attachment to a cross beam of the storage and retrieval unit, a girder portion (18) pivotally linked to the connection portion (12) by means of a spindle (16), a guide roller (20) rotatably borne by the girder portion (18), a supporting unit (22) rigidly connected to the cross beam, and a resilient element (38), which is in direct or indirect contact with the girder portion (18) on one side and a contact surface (36) of the supporting unit (22) on the other side in such a way as to bias the girder portion (18) toward rotation about the spindle (16) in the direction of the cross beam. The invention further relates to a storage and retrieval unit (100) comprising at least one such guide roller arrangement, and to a method for mounting a guide roller arrangement of this kind.

The present invention relates to a guide roller arrangement for a storage and retrieval unit, to a storage and retrieval unit comprising at least one such guide roller arrangement, and to a method for mounting a guide roller arrangement of this kind on a storage and retrieval unit.

Storage and retrieval units are typically guided by rollers that are arranged on the two opposite sides of a rail and thus provide lateral guidance and ensure that the unit rolls in a precise straight line. For this purpose, the rollers are adjusted to a defined gap from the rail and rigidly screwed in that position.

This gap is necessary to compensate for any tolerances in the rail since the rollers, once adjusted and screwed, are arranged immovably relative to functional components of the storage and retrieval unit. On the other hand, however, this gap means that the storage and retrieval unit can oscillate back and forth as it travels between the two rollers. In turn, this means that the rollers may lose contact with the rail in some portions, and when they come back into contact with the rail, they first have to be accelerated up to the traveling speed of the storage and retrieval unit; in those cases they may briefly scrape over the rail.

Firstly, this behavior leads to high, inconsistent wear on the rollers, and secondly, it generates a higher noise level during operation of the storage and retrieval unit. In addition, besides the just-described disadvantageous, hard-to-predict wear performance of the rollers, the above-described arrangement from the prior art has unsatisfactory maintainability since the rollers are difficult to reach and adjust.

Therefore, the problem addressed by the present invention is to create a novel guide roller arrangement for a storage and retrieval unit that remedies the above-described disadvantages of the known prior art and is distinguished on account of low wear, better accessibility and maintainability and, as a result, simpler mounting.

For this purpose, the guide roller arrangement according to the invention comprises a connection portion configured to enable rigid attachment to a cross beam of the storage and retrieval unit, a girder portion pivotally linked to the connection portion by means of a spindle, a guide roller rotatably borne by the girder portion, a supporting unit rigidly connected to the cross beam, and a resilient element, which is in direct or indirect contact with the girder portion on one side and a contact surface of the supporting unit on the other side in such a way as to bias the girder portion toward rotation about the spindle in the direction of the cross beam.

Since, in this way, the roller is pushed toward the rail by the action of the resilient element, the roller is always in contact with the storage and retrieval unit when said unit is in motion, so smooth running of the roller, and thus lower wear and considerably quieter operation, can be achieved. Furthermore, since a predetermined spring deflection can be provided by the resilient element, impacts caused by relatively small surface irregularities in the rail can be absorbed. In addition, by pivotally linking the girder portion to the attachment portion, better accessibility and simpler mounting of the guide roller arrangement can be achieved, as will become clear in particular from the method according to the invention described below for mounting a guide roller arrangement of this kind.

In a preferred embodiment, to optimally hold the guide roller on the girder portion, the girder portion can be formed having two parts, each extending on one side of the guide roller in relation to the axis of rotation thereof. In this case, a single continuous spindle can be provided through the guide roller and the two parts of the girder portion, or the guide roller can be mounted on each of the two portions independently.

In addition, in a particularly simple embodiment the resilient element can be formed by a helical spring; it goes without saying that, alternatively, it would also be possible to provide resilient elements of a different construction, such as different types of springs or a suitable resiliently deformable material that can exert a restoring force upon deformation.

To ensure the resilient element is suitably protected from dirt and the like, the supporting unit can further comprise a sleeve portion, which extends from the contact surface and houses the resilient element at least in some portions. This sleeve portion can possibly also be used as an abutment element for firmly limiting the spring deflection of the resilient element such that the spring deflection provided by the resilient element extends over such a distance until the sleeve portion comes into contact with a corresponding counterpart of the girder portion.

To further simplify the mounting and protect against loss thereof, the resilient element can furthermore be rigidly attached to the supporting unit.

To allow the supporting unit to be adjusted relative to the girder portion and to thus make it possible to adjust first the spring bias and second, where applicable, the above-described spring deflection between the sleeve portion and the girder portion, the supporting unit can comprise a main body rigidly connected to the cross beam, and an adjustment element that is movable relative to the main body, the contact surface being associated with the adjustment element and accordingly being movable together therewith.

In this embodiment, the main body can comprise in particular a threaded rod and the adjustment element can comprise an internal thread and possibly a lock nut screwable thereon. Therefore, by screwing on the adjustment element up to a predetermined position, it is possible to adjust said adjustment element and thus also the contact surface and, where applicable, the sleeve portion associated therewith, the lock nut being able to be used to lock this arrangement.

The present invention also relates to a storage and retrieval unit comprising at least one guide roller arrangement according to the invention, preferably a plurality of guide roller arrangements of this kind, which furthermore are preferably arranged in pairs such that the guide rollers are each guided on a rail opposite one another.

It goes without saying that, alternatively, as opposed to a guide roller unit according to the invention having its above-described absorption properties, it is also possible to provide a rigidly mounted guide roller; as a result, however, the advantages according to the invention of simpler mounting, quieter running and lower wear may, in some circumstances, not be achieved to the same extent as when respective pairs of guide roller arrangements according to the invention are provided. In any case, it would also be conceivable to mechanically couple the two guide rollers in terms of their rotation, such that even a roller that is not currently being contacted can be kept in motion. By way of example, this could be done by means of a toothed belt, by which the movement of one roller could also be transmitted to the others. In some circumstances, this principle may also be implementable in the above-described guide roller units having rigidly attached guide rollers from the prior art, in such a way that if one of the two guide rollers loses contact with the rail and then shortly thereafter regains contact with it, said roller is already in motion and does not have to be suddenly accelerated. In an embodiment of this kind of a storage and retrieval unit, however, the advantage according to the invention of simpler mounting would again not be achieved to the same extent and additional components would actually be necessary.

Lastly, the present invention relates to a method for mounting a guide roller arrangement according to the invention on a storage and retrieval unit, said method comprising the steps of attaching the connection portion to a cross beam of the storage and retrieval unit and attaching the supporting unit to the cross beam together with the resilient element in such a way that the resilient element is in direct or indirect contact with the girder portion on one side and a contact surface of the supporting unit on the other side.

If the guide roller arrangement is one from the above-described embodiment, in which the supporting unit comprises a main body and an adjustment element that is movable relative to the main body, a step of moving the adjustment element into a working position can also be provided, a small distance preferably being left, when in the working position, between the supporting unit, in particular the sleeve, and the girder portion in relation to the pivot direction of the girder portion about the spindle. This mounting step accordingly leads to adaptation of the firm limitation of the spring deflection already described above. By way of example, this small distance could be similar to the distance that corresponds, in the above-described manner in guide roller arrangements from the prior art, to the gap for absorbing tolerances of the rail.

Further features and advantages of the present invention will become clear from the following description of an embodiment when taken together with the accompanying drawings, in which:

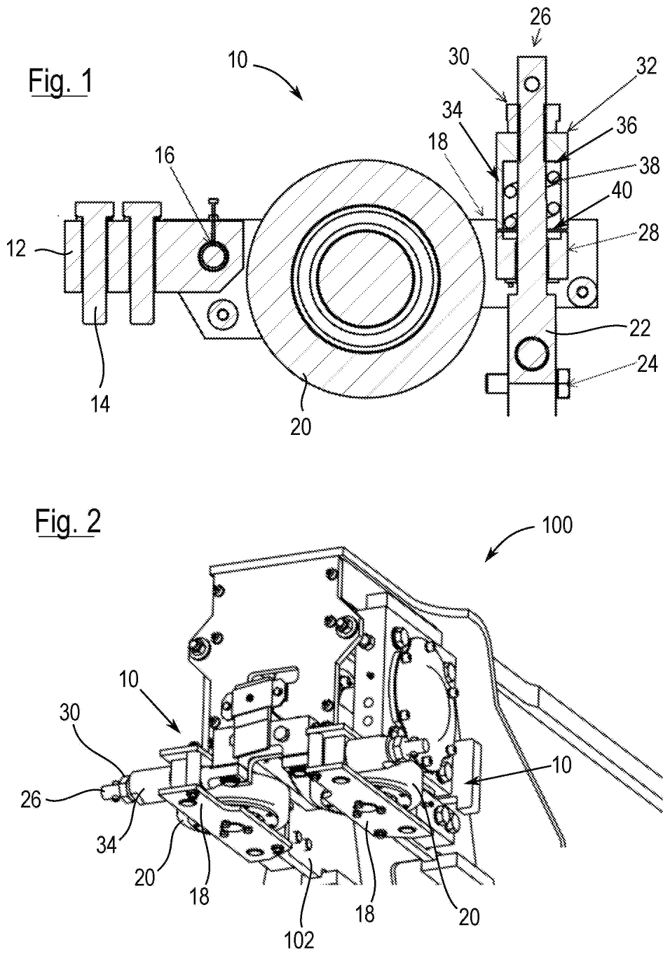

FIG. 1 is a schematic cross-sectional view of a guide roller arrangement according to the invention; and

FIG. 2: is an isometric view of two of the guide roller arrangements from

FIG. 1 in a state mounted on a cross beam of a storage and retrieval unit.

FIG. 1 is a schematic cross-sectional view of a guide roller arrangement according to the invention for a storage and retrieval unit, said guide roller arrangement being denoted in general terms by reference numeral 10. First, the arrangement 10 comprises a connection portion 12, which can be attached to a cross beam (not shown in FIG. 1) of a storage and retrieval unit by means of fasteners 14, such as rivets or screws. A girder portion 18 is pivotally linked to the attachment portion 12 by means of a spindle 16 and in turn rotatably bears a guide roller 20.

Since the sectional plane in the illustration shown in FIG. 1 extends through the guide roller 20 and, in accordance with the mounted state from FIG. 2, the arrangement 10 is viewed from above, only one part of the girder portion 18 located beneath the guide roller 20 is shown; in the embodiment illustrated, however, a second part not initially visible in FIG. 1 is also provided, said part extending in parallel with the illustrated part and symmetrically with the other, i.e. top, side of the guide roller 20 in relation to the sectional plane.

A further fastening point of the guide roller arrangement 10 to the cross beam (not shown in FIG. 1) of the storage and retrieval unit is associated with a supporting unit 22, at which point a connecting element 24, such as a screw or a rivet, likewise establishes said connection. In turn, the supporting unit 22 comprises a main body 26, which is in the form of a threaded rod and extends between the two parts of the girder portion through a pressure chock 28 associated therewith.

Furthermore, an adjustment element 32 having an internal thread is also provided, screwed onto the threaded rod 26, and is additionally locked by a lock nut 30. The adjustment element 32 further comprises, on one side, a sleeve portion 34, which extends substantially concentrically with the threaded rod 26, and, on the other side, a contact surface 36, which forms a first bearing surface for a helical spring 38 held inside the sleeve portion 34. At its other end, the helical spring 38 is supported against the above-mentioned pressure chock 28, and accordingly provides a bias for the girder portion 18 in terms of rotation about the spindle 16 in the downward direction in FIG. 1.

Lastly, reference is made to the distance 40 provided between the lower end of the sleeve portion 34 in FIG. 1 and the pressure chock 28 as a result of the adjustment of the adjustment element 32. This distance 40 limits the possible spring deflection provided by the helical spring 38 since, when it is exceeded during rotation of the girder portion 18 about the spindle 16 in the upward direction in FIG. 1, the sleeve portion 34 strikes the pressure chock 28 and the spring deflection is thus firmly limited.

Providing the spring element 38 ensures that, during operation of the arrangement 10, the roller 20 is in constant contact with a rail (not shown) at all times, the rebound of the roller 20 together with its girder portion 18 when traveling over surface irregularities on the rail being limited by the pressure chock 28 striking the sleeve portion 34.

FIG. 2 now shows two of the guide roller arrangements 10 shown in FIG. 1 in a state mounted on a cross beam 102 of a storage and retrieval unit 100. In this case, the two guide roller arrangements 10 are positioned opposite one another such that between their two rollers 20 it is possible to hold a rail with which the two rollers 20 are in contact on both opposite sides. Furthermore, the two-part structure of the two girder portions 18 can be seen in FIG. 2, as can the two protruding threaded rods 26 on which the sleeve portions 34 are mounted, inside which the helical springs 38 providing the contact pressure of the two rollers 20 on the rail are held.

1. A guide roller arrangement (10) for a storage and retrieval unit (100), comprising:
a connection portion (12) configured to enable rigid attachment to a cross beam (102) of the storage and retrieval unit (100);
a girder portion (18) pivotally linked to the connection portion (12) by means of a spindle (16);
a guide roller (20) rotatably borne by the girder portion (18);
a supporting unit (22) rigidly connected to the cross beam (102); and
a resilient element (38), which is in direct or indirect contact with the girder portion (18) on one side and a contact surface (36) of the supporting unit (22) on the other side in such a way as to bias the girder portion (18) toward rotation about the spindle (16) in the direction of the cross beam (102).

2. The guide roller arrangement (10) according to claim 1,
wherein the girder portion (18) is formed having two parts, each extending on one side of the guide roller (20) in relation to the axis of rotation thereof.

3. The guide roller arrangement (10) according to either claim 1 or claim 2, wherein the resilient element (38) is formed by a helical spring (38).

4. The guide roller arrangement (10) according to any of the preceding claims,
wherein the supporting unit (22) comprises a sleeve portion (34), which extends from the contact surface (36) and houses the resilient element (38) at least in some portions.

5. The guide roller arrangement (10) according to any of the preceding claims,
wherein the resilient element (38) is rigidly attached to the supporting unit (22).

6. The guide roller arrangement (10) according to any of the preceding claims,
wherein the supporting unit (22) comprises a main body (26) rigidly connected to the cross beam, and an adjustment element (32), which is movable relative to the main body (26), wherein the contact surface (36) is associated with the adjustment element (32).

7. The guide roller arrangement (10) according to claim 6,
wherein the main body (26) comprises a threaded rod (26) and the adjustment element (32) comprises an internal thread and possibly a lock nut (30) screwable thereon.

8. A storage and retrieval unit (100) comprising at least one guide roller arrangement (10) according to any of the preceding claims, preferably a plurality of such guide roller arrangements (10), which furthermore are preferably arranged in pairs such that the guide rollers (20) are each guided on a rail opposite one another.

9. The storage and retrieval unit (100) according to claim 8,
wherein the two guide rollers (20) are mechanically coupled in terms of their rotation.

10. Method for mounting a guide roller arrangement (10) according to any of claims 1 to 7 on a storage and retrieval unit (100), said method comprising the following steps:
attaching the connection portion (12) to a cross beam (102) of the storage and retrieval unit (100); and
attaching the supporting unit (22) to the cross beam (102) together with the resilient element (38) in such a way that the resilient element (38) is in direct or indirect contact with the girder portion (18) on one side and a contact surface (36) of the supporting unit (22) on the other side.

11. The method according to claim 10, wherein the guide roller arrangement (10) is one according to any of claims 6 and 7, further comprising the step of moving the adjustment element (32) into a working position, wherein, in the working position, a small distance is preferably left between the supporting unit (22), in particular the sleeve portion (34), and the girder portion (18) in relation to the pivot direction of the girder portion (18) about the spindle (16).
